(19) United States
(12) Patent Application Publication
(10) Pub. No.: US 2018/0288779 A1
(43) Pub. Date: Oct. 4, 2018

(54) Method and device for processing data transmission

(71) Applicant: ZTE Corporation, Shenzhen (CN)

(72) Inventors: Bo DAI, Shenzhen (CN); Shuanshuan WU, Shenzhen (CN); Guanghui YU, Shenzhen (CN); Lin CHEN, Shenzhen (CN); Ying HUANG, Shenzhen (CN)

(21) Appl. No.: 15/525,142

(22) PCT Filed: Apr. 2, 2015
(86) PCT No.: PCT/CN2015/075808

§ 371 Date: May 8, 2017

(30) Foreign Application Priority Data
Nov. 7, 2014 (CN) 201410623902.0

(51) Int. Cl. H04W 72/12; H04W 48/16

(52) U.S. Cl. CPC H04W 72/12; H04W 72/042; H04W 48/16

(57) ABSTRACT

A method and device for processing data transmission are provided. The method includes that: an auxiliary User Equipment (UE) detects data scheduling information sent by a transmission node to a target UE, the data scheduling information including: scheduling information of the target UE sending data to the transmission node; and the auxiliary UE receives the data sent by the target UE to the transmission node according to the data scheduling information.

### TECHNICAL FIELD

The present disclosure relates to the field of communications, and in particular to a method and device for processing data transmission.

### BACKGROUND

In order to ensure data transmission performance in a radio communication system, an Automatic Repeat Request (ARQ)/Hybrid Automatic Repeat Request (HARQ) mechanism is adopted. Data receiving performance is ensured by data repeat merging for many times. Under a scenario where a channel environment is relatively severe such as a basement, a corner and a scenario where a penetration loss is relatively large, in order to ensure the data transmission performance, retransmission is required, thus improving data receiving power and ensuring performance, so system resource overheads will be increased. In addition, in order to avoid user interference between different cells, it is necessary to reduce data sending power at cell edges. In order to ensure the data transmission performance, resist against interference and power and reduce losses, it is necessary to allocate more resources so as to ensure the data performance, and it is necessary to repeat data for many times, thus resulting in reduction of the utilization efficiency of system resources.

A current data transmission processing mode results in data transmission performance loss.

### SUMMARY

In the embodiments of the present disclosure, provided are methods and devices for processing data transmission, which are intended to at least provide a basis for solving the problem of data transmission performance loss in a current data transmission processing mode.

According to an aspect of an embodiment of the present disclosure, a method for processing data transmission is provided, which may include that: an auxiliary User Equipment (UE) detects data scheduling information sent by a transmission node to a target UE, the data scheduling information include scheduling information of the target UE sending data to the transmission node; and the auxiliary UE receives the data sent by the target UE to the transmission node according to the data scheduling information.

In certain embodiments, the method may further include that: the auxiliary UE transmits the received data to the transmission node; or, if the auxiliary UE confirms that it is unnecessary to transmit the received data to the transmission node, the received data are emptied.

In certain embodiments, the step that the auxiliary UE transmits the received data to the transmission node may include that: the auxiliary UE detects retransmission data scheduling information or feedback information sent by the transmission node to the target UE; the auxiliary UE transmits the received data to the transmission node according to the retransmission data scheduling information or feedback information; and/or, after receiving the data, the auxiliary UE transmits the received data over a resource where the target UE retransmits the data.

In certain embodiments, the step that the auxiliary UE transmits the received data over a resource where the target UE retransmits the data after receiving the data may include that: when the target UE transmits data over X sub-frames according to the data scheduling information, the auxiliary UE transmits, after receiving the data, the received data over Y sub-frames in the X sub-frames and over the resource where the target UE retransmits the data.

In certain embodiments, the step that the auxiliary UE transmits the received data to the transmission node may include one of the steps that: the auxiliary UE transmits the received data to the transmission node in the same mode as the target UE transmits or retransmits the data; the auxiliary UE transmits the received data to the transmission node in a pre-defined mode; the auxiliary UE transmits the received data to the transmission node in a mode indicated by the transmission node; and the auxiliary UE directly forwards the data to the transmission node without decoding.

In certain embodiments, the data scheduling information may include: auxiliary transmission mode information, the auxiliary transmission mode information including: whether the auxiliary UE receives data sent by the target UE, and/or whether the auxiliary UE transmits the received data to the transmission node.

In certain embodiments, the step that the auxiliary UE confirms that it is unnecessary to transmit the received data to the transmission node may include that: after detecting an information Acknowledgement (ACK), sent by the transmission node to the target UE, for confirming successful data receiving, the auxiliary UE confirms that it is unnecessary to transmit the received data to the transmission node.

In certain embodiments, the step that the auxiliary UE detects the data scheduling information sent by the transmission node to the target UE may include that: the auxiliary UE receives configuration information sent by the transmission node, the configuration information including at least one of the following: identification information of the target UE, transmission mode information of the target UE, information about a downlink control channel bearing the data scheduling information, and trigger information for triggering the auxiliary UE to assist the target UE in data transmission; and the auxiliary UE detects the data scheduling information according to the configuration information.

In certain embodiments, under the condition that the data scheduling information is transmitted by using an enhanced Physical Downlink Control Channel (ePDCCH), the configuration information may further include configuration information associated with the ePDCCH, the configuration information associated with the ePDCCH including at least one of the following: a sub-frame position in which the ePDCCH is located, a start symbol position of Orthogonal Frequency Division Multiplexing (OFDM), number of Physical Resource Block (PRB) sets, number and index of PRBs in PRB sets, a transmission mode, a scrambling initial value parameter, and a Demodulation Reference Signal (DMRS) scrambling initial value.

In certain embodiments, the step that the auxiliary UE detects the data scheduling information may include at least one of the steps that: the auxiliary UE detects the data scheduling information only in a common search space, or only in a UE-specific search space, or in a common search space and a UE-specific search space; the auxiliary UE detects the data scheduling information in a specific sub-frame set; the auxiliary UE detects the data scheduling information according to a specific Downlink Control Information (DCI) format; and under the condition that the data scheduling information is transmitted by using the ePDCCH, the auxiliary UE detects the data scheduling information by using a specific ePDCCH set.

In certain embodiments, the step that the auxiliary UE detects the data scheduling information may include that: the auxiliary UE receives a group Identity (ID) sent by the transmission node, a search space of the data scheduling information being determined according to the group ID; and the auxiliary UE detects the data scheduling information in the search space determined according to the group ID.

In certain embodiments, the group ID and/or UE-specific ID may be used in at least one of the following modes: detecting a part of sub-frame sets by using the group ID, and detecting a part of sub-frame sets by using the UE-specific ID; defining two candidate resource sets, detecting one of the candidate resource sets by using the UE-specific ID, and detecting the other candidate resource set by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID.

In certain embodiments, the step that the auxiliary UE detects the data scheduling information may include that: the auxiliary UE acquires an ID of the target UE or the group ID; and the auxiliary UE detects and obtains the data scheduling information according to the ID of the target UE or the group ID, the data scheduling information being scrambled by the transmission node via the ID of the target UE or the group ID.

According to another aspect of the present disclosure, a method for processing data transmission is provided, which may include that: a transmission node sends data scheduling information to a target UE; and the transmission node receives data transmitted by an auxiliary UE, or data transmitted by the target UE and the auxiliary UE, the data transmitted by the auxiliary UE being data received by the auxiliary UE according to the data scheduling information and transmitted by the target UE to the transmission node.

In certain embodiments, the step that the transmission node receives data transmitted by the auxiliary UE may include that: the transmission node sends retransmission data scheduling information or feedback information to the target UE; and the transmission node receives data retransmission by the target UE and/or the auxiliary UE, the data retransmission by the auxiliary UE being the received data transmitted to the transmission node according to the retransmission data scheduling information or the feedback information; and/or, after the auxiliary UE receives the data, the transmission node receives the data retransmission over the same resource where the auxiliary UE and the target UE transmit the data.

In certain embodiments, the transmission node may receive the data transmitted by the auxiliary UE in a predetermined mode, the predetermined mode including one of the following: independently transmitting the data by the target UE, independently transmitting the data by the auxiliary UE, and cooperatively retransmitting the data by the target UE and the auxiliary UE to decode the data respectively.

In certain embodiments, the data scheduling information may include: auxiliary transmission mode information, the auxiliary transmission mode information including: whether the auxiliary UE receives data sent by the target UE, and/or whether the auxiliary UE transmits the received data to the transmission node.

In certain embodiments, the method may further include that: the transmission node sends configuration information to the auxiliary UE, the configuration information including at least one of the following: identification information of the target UE, transmission mode information of the target UE, information about a downlink control channel bearing the data scheduling information, and trigger information for triggering the auxiliary UE to assist the target UE in data transmission.

In certain embodiments, under the condition that the data scheduling information is transmitted by using an ePDCCH, the configuration information may further include configuration information associated with the ePDCCH, the configuration information associated with the ePDCCH including at least one of the following: a sub-frame position in which the ePDCCH is located, a start symbol position of OFDM, number of PRB sets, number and index of PRBs in PRB sets, a transmission mode, a scrambling initial value parameter, and a DMRS scrambling initial value.

In certain embodiments, the method may further include that: the transmission node sends a group ID to the auxiliary UE and the target UE, the group ID being used for determining a search space for the data scheduling information.

In certain embodiments, the group ID and/or UE-specific ID may be used in at least one of the following modes: detecting a part of sub-frame sets by using the group ID, and detecting a part of sub-frame sets by using the UE-specific ID; defining two candidate resource sets, detecting one of the candidate resource sets by using the UE-specific ID, and detecting the other candidate resource set by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID.

According to a further aspect of the embodiment of the present disclosure, a method for processing data transmission is provided, which may include that: a target UE receives a group ID sent by a transmission node, the group ID being used for determining a search space for data scheduling information, and the data scheduling information being used for acquiring, by an auxiliary UE, data transmitted by the target UE to the transmission node.

In certain embodiments, the group ID and/or UE-specific ID may be used in at least one of the following modes: detecting a part of sub-frame sets by using the group ID, and detecting a part of sub-frame sets by using the UE-specific ID; defining two candidate resource sets, detecting one of the candidate resource sets by using the UE-specific ID, and detecting the other candidate resource set by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID.

In certain embodiments, the data scheduling information may include: auxiliary transmission mode information, the auxiliary transmission mode information including: whether the auxiliary UE receives data sent by the target UE, and/or whether the auxiliary UE transmits the received data to the transmission node.

According to a further aspect of the embodiment of the present disclosure, a device for processing data transmission is provided, which may be applied to an auxiliary UE and may include: a detection module, configured to detect data scheduling information sent by a transmission node to a target UE, the data scheduling information including: scheduling information of the target UE sending data to the transmission node; and a first receiving module, configured to receive the data sent by the target UE to the transmission node according to the data scheduling information.

In certain embodiments, the device may further include: a first transmission module, configured to transmit the received data to the transmission node; or, a confirmation module, configured to empty, when confirming that it is unnecessary to transmit the received data to the transmission node, the received data.

In certain embodiments, the first transmission module may include: a first transmission sub-module, configured to detect retransmission data scheduling information or feedback information sent by the transmission node to the target UE, and transmit the received data to the transmission node according to the retransmission data scheduling information or feedback information; and/or, a second transmission sub-module, configured to transmit, after receiving the data, the received data over a resource where the target UE retransmits the data.

In certain embodiments, the second transmission sub-module may include: a retransmitting unit, configured to transmit, when the target UE transmits data over X sub-frames according to the data scheduling information, the received data over Y sub-frames in the X sub-frames after receiving the data and over the resource where the target UE retransmits the data.

In certain embodiments, the first transmission module may include one of the following: a third transmission sub-module, configured to transmit the received data to the transmission node in the same mode as the target UE transmits or retransmits the data; a fourth transmission sub-module, configured to transmit the received data to the transmission node in a pre-defined mode; a fifth transmission sub-module, configured to transmit the data in a mode indicated by the transmission node; and a forwarding sub-module, configured to directly forward the data to the transmission node without decoding.

In certain embodiments, the data scheduling information may include: auxiliary transmission mode information, the auxiliary transmission mode information including: whether the auxiliary UE receives data sent by the target UE, and/or whether the auxiliary UE transmits the received data to the transmission node.

In certain embodiments, the confirmation module may include: a confirmation sub-module, configured to confirm that it is unnecessary to transmit the received data to the transmission node after detecting an ACK, sent by the transmission node to the target UE, for confirming successful data receiving.

In certain embodiments, the detection module may include a first receiving sub-module and a first detection sub-module, and a first receiving sub-module is configured to receive configuration information sent by the transmission node, and the configuration information include at least one of the following: identification information of the target UE, transmission mode information of the target UE, information about a downlink control channel bearing the data scheduling information, and trigger information for triggering the auxiliary UE to assist the target UE in data transmission; and the first detection sub-module is configured to detect the data scheduling information according to the configuration information.

In certain embodiments, under the condition that the data scheduling information is transmitted by using an ePDCCH, the configuration information may further include configuration information associated with the ePDCCH, the configuration information associated with the ePDCCH including at least one of the following: a sub-frame position in which the ePDCCH is located, a start symbol position of OFDM, number of PRB sets, number and index of PRBs in PRB sets, a transmission mode, a scrambling initial value parameter, and a DMRS scrambling initial value.

In certain embodiments, the detection module may include at least one of the following: a second detection sub-module, configured to detect the data scheduling information only in a common search space, or only in a UE-specific search space, or in a common search space and a UE-specific search space; a third detection sub-module, configured to detect the data scheduling information in a specific sub-frame set; a fourth detection sub-module, configured to detect the data scheduling information according to a specific DCI format; and a fifth detection sub-module, configured to detect, under the condition that the data scheduling information is transmitted by using the ePDCCH, the data scheduling information by using a specific ePDCCH set.

In certain embodiments, the detection module may include: a second receiving sub-module, configured to receive a group ID sent by the transmission node, a search space of the data scheduling information being determined according to the group ID; and a sixth detection sub-module, configured to detect the data scheduling information in the search space determined according to the group ID.

In certain embodiments, the group ID and/or UE-specific ID may be used in at least one of the following modes: detecting a part of sub-frame sets by using the group ID, and detecting a part of sub-frame sets by using the UE-specific ID; defining two candidate resource sets, detecting one of the candidate resource sets by using the UE-specific ID, and detecting the other candidate resource set by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID.

In certain embodiments, the detection module may include: an acquisition sub-module, configured to acquire an ID of the target UE or the group ID; and an obtaining sub-module, configured to detect and obtain the data scheduling information according to the ID of the target UE or the group ID, the data scheduling information being scrambled by the transmission node via the ID of the target UE or the group ID.

According to a further aspect of the embodiment of the present disclosure, a device for processing data transmission is provided, which may be applied to a transmission node and may include: a first sending module, configured to send data scheduling information to a target UE; and a second receiving module, configured to receive data transmitted by an auxiliary UE, or data transmitted by the target UE and the auxiliary UE, the data transmitted by the auxiliary UE being data received by the auxiliary UE according to the data scheduling information and transmitted by the target UE to the transmission node.

In certain embodiments, the second receiving module may include: a sending sub-module, configured to send retransmission data scheduling information or feedback information to the target UE; a third receiving sub-module, configured to receive the data transmitted by the auxiliary UE to the transmission node according to the retransmission data scheduling information or the feedback information; and/or, a fourth receiving sub-module, configured to receive, after the auxiliary UE receives the data, the data retransmission over the same resource where the auxiliary UE and the target UE transmit the data.

In certain embodiments, the device may further include: a fifth receiving sub-module, configured to receive the data transmitted by the auxiliary UE in a predetermined mode, the predetermined mode including one of the following: independently transmitting the data by the target UE, independently transmitting the data by the auxiliary UE, and cooperatively retransmitting the data by the target UE and the auxiliary UE to decode the data respectively.

In certain embodiments, the data scheduling information may include: auxiliary transmission mode information, the auxiliary transmission mode information including: whether the auxiliary UE receives data sent by the target UE, and/or whether the auxiliary UE transmits the received data to the transmission node.

In certain embodiments, the device may further include: a second sending module, configured to send configuration information to the auxiliary UE, the configuration information including at least one of the following: identification information of the target UE, transmission mode information of the target UE, information about a downlink control channel bearing the data scheduling information, and trigger information for triggering the auxiliary UE to assist the target UE in data transmission.

In certain embodiments, under the condition that the data scheduling information is transmitted by using an ePDCCH, the configuration information may further include configuration information associated with the ePDCCH, the configuration information associated with the ePDCCH including at least one of the following: a sub-frame position in which the ePDCCH is located, a start symbol position of OFDM, number of PRB sets, number and index of PRBs in PRB sets, a transmission mode, a scrambling initial value parameter, and a DMRS scrambling initial value.

In certain embodiments, the device may be further configured to send a group ID to the auxiliary UE and the target UE, the group ID being used for determining a search space for the data scheduling information.

In certain embodiments, the group ID and/or UE-specific ID may be used in at least one of the following modes: detecting a part of sub-frame sets by using the group ID, and detecting a part of sub-frame sets by using the UE-specific ID; defining two candidate resource sets, detecting one of the candidate resource sets by using the UE-specific ID, and detecting the other candidate resource set by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID.

According to a yet further aspect of the embodiment of the present disclosure, a device for processing data transmission is provided, which may include: a third receiving module, configured to receive a group ID sent by a transmission node, the group ID being used for determining a search space for data scheduling information, and the data scheduling information being used for acquiring, by an auxiliary UE, data transmitted by the target UE to the transmission node.

In certain embodiments, the group ID and/or UE-specific ID may be used in at least one of the following modes: detecting a part of sub-frame sets by using the group ID, and detecting a part of sub-frame sets by using the UE-specific ID; defining two candidate resource sets, detecting one of the candidate resource sets by using the UE-specific ID, and detecting the other candidate resource set by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID.

In certain embodiments, the data scheduling information may include: auxiliary transmission mode information, the auxiliary transmission mode information including: whether the auxiliary UE receives data sent by the target UE, and/or whether the auxiliary UE transmits the received data to the transmission node.

In the above embodiments of the present disclosure, an auxiliary UE detects data scheduling information sent by a transmission node to a target UE, the data scheduling information including: scheduling information of the target UE sending data to the transmission node; and the auxiliary UE receives the data sent by the target UE to the transmission node according to the data scheduling information. In the embodiments of the present disclosure, an auxiliary UE is introduced to at least provide a basis for solving the problem of data transmission performance loss in a current data transmission processing mode, thus improving the performance of a transmission node in receiving data sent by a target UE.

### BRIEF DESCRIPTION OF THE DRAWINGS

The drawings illustrated herein are intended to provide a further understanding of the present disclosure, and form a part of the present application. The schematic embodiments and illustrations of the present disclosure are intended to explain the present disclosure.

FIG. 1 is a flowchart 1 of a method for processing data transmission according to an embodiment of the present disclosure.

FIG. 2 is a flowchart 2 of a method for processing data transmission according to an embodiment of the present disclosure.

FIG. 3 is a block diagram 1 of a device for processing data transmission according to an embodiment of the present disclosure.

FIG. 4 is a block diagram 1 of a device for processing data transmission according to an exemplary embodiment of the present disclosure.

FIG. 5 is a block diagram 2 of a device for processing data transmission according to an exemplary embodiment of the present disclosure.

FIG. 6 is a block diagram 3 of a device for processing data transmission according to an exemplary embodiment of the present disclosure.

FIG. 7 is a block diagram 4 of a device for processing data transmission according to an exemplary embodiment of the present disclosure.

FIG. 8 is a block diagram 2 of a device for processing data transmission according to an embodiment of the present disclosure.

FIG. 9 is a block diagram 5 of a device for processing data transmission according to an exemplary embodiment of the present disclosure.

FIG. 10 is a schematic diagram 1 of UE collaboration data repeat according to an embodiment of the present disclosure.

FIG. 11 is a schematic diagram 2 of UE collaboration data repeat according to an embodiment of the present disclosure.

FIG. 12 is a schematic diagram 3 of UE collaboration data repeat according to an embodiment of the present disclosure.

### DETAILED DESCRIPTION OF THE EMBODIMENTS

The present disclosure will be illustrated herein below with reference to the drawings and in conjunction with the embodiments in detail. It is important to note that the embodiments in the present application and characteristics in the embodiments may be combined under the condition of no conflicts.

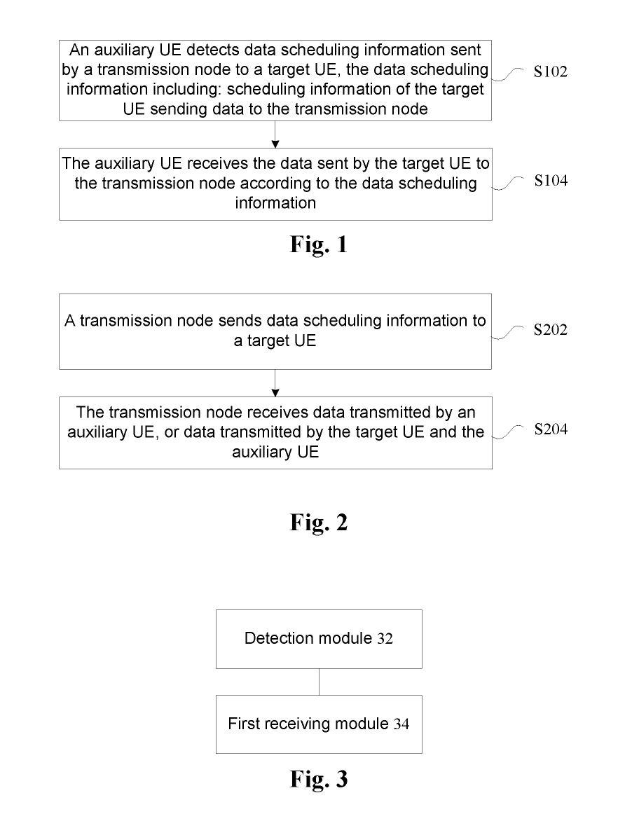

A method for processing data transmission is provided in the present embodiment. FIG. 1 is a flowchart 1 of a method for processing data transmission according to an embodiment of the present disclosure. As shown in FIG. 1, the flow includes the following steps S102 to S104.

At Step S102: An auxiliary UE detects data scheduling information sent by a transmission node to a target UE, the data scheduling information including: scheduling information of the target UE sending data to the transmission node.

At Step S104: The auxiliary UE receives the data sent by the target UE to the transmission node according to the data scheduling information.

By using the abovementioned steps, the auxiliary UE may receive the data transmitted by the target UE, thus making it possible to assist, by the auxiliary UE, the target UE in data transmission, at least providing a basis for solving the problem of data transmission performance loss in a current data transmission processing mode, and improving the performance of the transmission node in receiving data sent by the target UE.

As an exemplary implementation mode, since the auxiliary UE stores the data of the target UE, the auxiliary UE may transmit the received data to the transmission node, or under the condition that the auxiliary UE confirms that it is unnecessary to transmit the received data to the transmission node, the received data may be emptied, and a space occupied by the data may be saved. For example, after detecting the ACK message, sent by the transmission node to the target UE, for confirming successful data receiving, the auxiliary UE may confirm that it is unnecessary to transmit the received data to the transmission node. After it is determined that it is unnecessary to transmit the data, the data are emptied, thus saving the storage space.

As an exemplary implementation mode, the data stored in the auxiliary UE may be used for retransmitting. For example, the transmission node indicates that it is necessary to repeat certain data, which may result from bad channel conditions of the target UE. If the data are retransmission by the target UE, the transmission node cannot receive the data probably. At this time, the auxiliary UE may repeat the data. That is, in the exemplary implementation mode, the auxiliary UE may detect retransmission data scheduling information or feedback information sent by the transmission node to the target UE, and then may transmit the received data to the transmission node according to the retransmission data scheduling information or feedback information.

In another exemplary implementation mode, the auxiliary UE may directly send the received data to the transmission node. So, the target UE and the auxiliary UE transmit the same data, and it may be ensured that the transmission mode receives the data correctly. At this time, the auxiliary UE and the target UE may use the same resource, that is, after the auxiliary UE receives the data, the auxiliary UE and the target UE repeat the received data over the same resource where the data are transmitted. For example, when the target UE transmits data over X sub-frames according to the data scheduling information, the auxiliary UE retransmits, after receiving the data, the received data over Y sub-frames in the X sub-frames and over the same resource where the target UE transmits the data.

There may be many modes of transmitting, by the auxiliary UE, data to the transmission node. In an exemplary implementation mode, the step that the auxiliary UE transmits the received data to the transmission node may include one of the steps that: the auxiliary UE transmits the received data to the transmission node in the same mode as the target UE transmits or retransmits the data; the auxiliary UE transmits the received data to the transmission node in a pre-defined mode; the auxiliary UE transmits the data in a mode indicated by the transmission node; and the auxiliary UE directly forwards the data to the transmission node without decoding. These modes may be flexibly selected according to actual requirements.

In another exemplary implementation mode, the data scheduling information may further include: auxiliary transmission mode information, the auxiliary transmission mode information including: whether the auxiliary UE receives data sent by the target UE, and/or whether the auxiliary UE transmits the received data to the transmission node.

To better facilitate transmission, the transmission node may send relevant configuration information to the auxiliary UE, and the auxiliary UE receives the configuration information sent by the transmission node. In an exemplary implementation mode, the configuration information includes at least one of the following: identification information of the target UE, transmission mode information of the target UE, and a type of a downlink control channel bearing the data scheduling information; and the auxiliary UE detects the data scheduling information sent by the transmission node to the target UE according to the configuration information.

In an exemplary implementation mode, under the condition that the data scheduling information is transmitted by using an ePDCCH, the configuration information may further include configuration information associated with the ePDCCH, and the configuration information associated with the ePDCCH may include at least one of the following: a sub-frame position in which the ePDCCH is located, a start symbol position of OFDM, number of PRB sets, number and index of PRBs in PRB sets, a transmission mode, a scrambling initial value parameter, and a DMRS scrambling initial value.

There may be many modes of detecting the data scheduling information. In an exemplary implementation mode, the auxiliary UE may detect the data scheduling information by using at least one of the modes that: the auxiliary UE detects the data scheduling information only in a common search space, or only in a UE-specific search space, or in a common search space and a UE-specific search space; the auxiliary UE detects the data scheduling information in a specific sub-frame set; the auxiliary UE detects the data scheduling information according to a specific DCI format; and under the condition that the data scheduling information is transmitted by using the ePDCCH, the auxiliary UE detects the data scheduling information by using a specific ePDCCH set.

There may be many modes of detecting, by the auxiliary UE, the data scheduling information. In an exemplary implementation mode, the step that the auxiliary UE detects the data scheduling information may include that: the auxiliary UE receives a group ID sent by the transmission node, a search space of the data scheduling information being determined according to the group ID; and the auxiliary UE detects the data scheduling information in the search space determined according to the group ID. For example, the group ID and/or UE-specific ID are/is used in at least one of the following modes: detecting a part of sub-frame sets by using the group ID, and detecting a part of sub-frame sets by using the UE-specific ID; defining candidate resource sets, detecting the resource set 1 by using the UE-specific ID, and detecting the resource set 2 by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID. It is important to note that besides the abovementioned modes, the step that the auxiliary UE detects the data scheduling information may further include that: the auxiliary UE acquires an ID of the target UE or the group ID; and the auxiliary UE detects and obtains the data scheduling information according to the ID of the target UE or the group ID, the data scheduling information being scrambled by the transmission node via the ID of the target UE or the group ID.

The embodiment of the present disclosure provides a method for processing data transmission. FIG. 2 is a flowchart 2 of a method for processing data transmission according to an embodiment of the present disclosure. As shown in FIG. 2, the flow includes the following steps S202 to S204.

At Step S202: A transmission node sends data scheduling information to a target UE.

At Step S204: The transmission node receives data transmitted by an auxiliary UE, or data transmitted by the target UE and the auxiliary UE, the data transmitted by the auxiliary UE being data received by the auxiliary UE according to the data scheduling information and transmitted by the target UE to the transmission node.

By using the abovementioned steps, the transmission node sends the data scheduling information to the target UE. The transmission node may receive the data transmitted by the auxiliary UE, or may receive the data transmitted by both the target UE and the auxiliary UE, the data transmitted by the auxiliary UE being data received by the auxiliary UE according to the data scheduling information and transmitted by the target UE to the transmission node. The auxiliary UE transmits the data to the transmission node, thus making it possible to assist, by the auxiliary UE, the target UE in data transmission, at least providing a basis for solving the problem of data transmission performance loss in a current data transmission processing mode, and improving the performance of the transmission node in receiving data sent by the target UE.

The transmission node may receive the data transmitted by the auxiliary UE by using many modes. In an exemplary implementation mode, the step that the transmission node receives data transmitted by the auxiliary UE may include that: the transmission node sends retransmission data scheduling information or feedback information to the target UE; and the transmission node receives data retransmission by the target UE and/or the auxiliary UE, the data retransmission by the auxiliary UE being the received data transmitted to the transmission node according to the retransmission data scheduling information or the feedback information; and/or, after the auxiliary UE receives the data, the transmission node receives the data retransmission over the same resource where the auxiliary UE and the target UE transmit the data.

In an exemplary implementation mode, the transmission node may receive the data transmitted by the auxiliary UE in a predetermined mode, the predetermined mode including one of the following: independently transmitting the data by the target UE, independently transmitting the data by the auxiliary UE, and cooperatively retransmitting the data by the target UE and the auxiliary UE to decode the data respectively.

In an exemplary implementation mode, the data scheduling information may include: auxiliary transmission mode information, the auxiliary transmission mode information including: whether the auxiliary UE receives data sent by the target UE, and/or whether the auxiliary UE transmits the received data to the transmission node.

In an exemplary implementation mode, the transmission node sends configuration information to the auxiliary UE, and detects the data scheduling information sent by the transmission node to the target UE according to the configuration information, and the configuration information may include at least one of the following: identification information of the target UE, transmission mode information of the target UE, and a type of a downlink control channel bearing the data scheduling information. For example, under the condition that the data scheduling information is transmitted by using an ePDCCH, the configuration information may further include configuration information associated with the ePDCCH, the configuration information associated with the ePDCCH including at least one of the following: a sub-frame position in which the ePDCCH is located, a start symbol position of OFDM, number of PRB sets, number and index of PRBs in PRB sets, a transmission mode, a scrambling initial value parameter, and a DMRS scrambling initial value.

The transmission node may also send a group ID to the auxiliary UE and the target UE, the group ID being used for determining a search space for the data scheduling information. For example, the group ID and/or UE-specific ID may be used in at least one of the following modes: detecting a part of sub-frame sets by using the group ID, and detecting a part of sub-frame sets by using the UE-specific ID; defining candidate resource sets, detecting the resource set 1 by using the UE-specific ID, and detecting the resource set 2 by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID.

The embodiment of the present disclosure also provides a method for processing data transmission, which includes that: a target UE receives a group ID sent by a transmission node, the group ID being used for determining a search space for data scheduling information, and the data scheduling information being used for acquiring, by an auxiliary UE, data transmitted by the target UE to the transmission node. Under the condition that the target UE transmits data to the transmission node unsuccessfully, the auxiliary UE may transmit the received data to the transmission node, and the auxiliary UE may acquire the data transmitted by the target UE to the transmission node, thus making it possible to assist, by the auxiliary UE, the target UE in data transmission, at least providing a basis for solving the problem of data transmission performance loss in a current data transmission processing mode, and improving the performance of the transmission node in receiving data sent by the target UE.

In an exemplary implementation mode, the group ID and/or UE-specific ID may be used in at least one of the following modes: detecting a part of sub-frame sets by using the group ID, and detecting a part of sub-frame sets by using the UE-specific ID; defining candidate resource sets, detecting the resource set 1 by using the UE-specific ID, and detecting the resource set 2 by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID.

In an exemplary implementation mode, the data scheduling information may include: auxiliary transmission mode information, the auxiliary transmission mode information including: whether the auxiliary UE receives data sent by the target UE, and/or whether the auxiliary UE transmits the received data to the transmission node.

The embodiment of the present disclosure provides a device for processing data transmission, applied to an auxiliary UE. The device is configured to implement the abovementioned embodiment and an exemplary implementation mode. Those which have been illustrated will not be elaborated herein. Just as a term ‘module’ used below, the combination of software and/or hardware with predetermined functions may be implemented. Although the device described by the following embodiment is better implemented by software, the implementation of hardware or the combination of software and hardware may be possible and conceived.

FIG. 3 is a block diagram 1 of a device for processing data transmission according to an embodiment of the present disclosure. As shown in FIG. 3, the device includes: a detection module 32 and a first receiving module 34. Each module will be briefly described herein below.

The detection module 32 is configured to detect data scheduling information sent by a transmission node to a target UE, the data scheduling information including: scheduling information of the target UE sending data to the transmission node.

The first receiving module 34 is configured to receive the data sent by the target UE to the transmission node according to the data scheduling information.

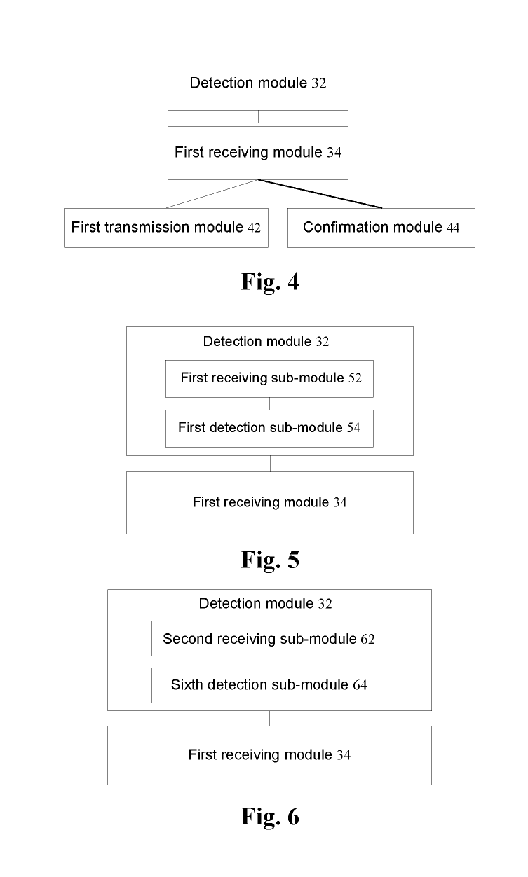

FIG. 4 is a block diagram 1 of a device for processing data transmission according to an exemplary embodiment of the present disclosure. As shown in FIG. 4, the device further includes a first transmission module 42 or a confirmation module 44.

The first transmission module 42 is configured to transmit the received data to the transmission node, and the confirmation module 44 is configured to empty, when confirming that it is unnecessary to transmit the received data to the transmission node, the received data.

The first transmission module 42 may include: a first transmission sub-module, configured to detect retransmission data scheduling information or feedback information sent by the transmission node to the target UE, and transmit the received data to the transmission node according to the retransmission data scheduling information or feedback information; and/or, a second transmission sub-module, configured to transmit, after receiving the data, the received data over a resource where the target UE retransmits the data.

In an exemplary implementation mode, the second transmission sub-module may include: a retransmitting unit, configured to transmit, when the target UE transmits data over X sub-frames according to the data scheduling information, the received data over Y sub-frames in the X sub-frames after receiving the data and over the resource where the target UE retransmits the data.

The first transmission module 42 may include one of the following: a third transmission sub-module, configured to transmit the received data to the transmission node in the same mode as the target UE transmits or retransmits the data; a fourth transmission sub-module, configured to transmit the received data to the transmission node in a pre-defined mode; a fifth transmission sub-module, configured to transmit the data in a mode indicated by the transmission node; and a forwarding sub-module, configured to directly forward the data to the transmission node without decoding.

In the present embodiment, the data scheduling information may include: auxiliary transmission mode information, the auxiliary transmission mode information including: whether the auxiliary UE receives data sent by the target UE, and/or whether the auxiliary UE transmits the received data to the transmission node.

The confirmation module 44 may include: a confirmation sub-module, configured to confirm that it is unnecessary to transmit the received data to the transmission node after detecting an ACK, sent by the transmission node to the target UE, for confirming successful data receiving.

FIG. 5 is a block diagram 2 of a device for processing data transmission according to an exemplary embodiment of the present disclosure. As shown in FIG. 5, the detection module 32 includes a first receiving sub-module 52 and a first detection sub-module 54.

The first receiving sub-module 52 is configured to receive configuration information sent by the transmission node, the configuration information including at least one of the following: identification information of the target UE, transmission mode information of the target UE, and a type of a downlink control channel bearing the data scheduling information.

The first detection sub-module 54 is configured to detect the data scheduling information according to the configuration information.

In an exemplary implementation mode, under the condition that the data scheduling information is transmitted by using an ePDCCH, the configuration information further includes configuration information associated with the ePDCCH, the configuration information associated with the ePDCCH including at least one of the following: a sub-frame position in which the ePDCCH is located, a start symbol position of OFDM, number of PRB sets, number and index of PRBs in PRB sets, a transmission mode, a scrambling initial value parameter, and a DMRS scrambling initial value.

In an exemplary implementation mode, the detection module 32 may include at least one of the following: a second detection sub-module, configured to detect the data scheduling information only in a common search space, or only in a UE-specific search space, or in a common search space and a UE-specific search space; a third detection sub-module, configured to detect the data scheduling information in a specific sub-frame set; a fourth detection sub-module, configured to detect the data scheduling information according to a specific DCI format; and a fifth detection sub-module, configured to detect, under the condition that the data scheduling information is transmitted by using the ePDCCH, the data scheduling information by using a specific ePDCCH set.

FIG. 6 is a block diagram 3 of a device for processing data transmission according to an exemplary embodiment of the present disclosure. As shown in FIG. 6, the detection module 32 includes a second receiving sub-module 62 and a sixth detection sub-module 64.

The second receiving sub-module 62 is configured to receive a group ID sent by the transmission node, a search space of the data scheduling information being determined according to the group ID, and the sixth detection sub-module 64 is configured to detect the data scheduling information in the search space determined according to the group ID.

In an exemplary implementation mode, the group ID and/or UE-specific ID may be used in at least one of the following modes: detecting a part of sub-frame sets by using the group ID, and detecting a part of sub-frame sets by using the UE-specific ID; defining candidate resource sets, detecting the resource set 1 by using the UE-specific ID, and detecting the resource set 2 by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID.

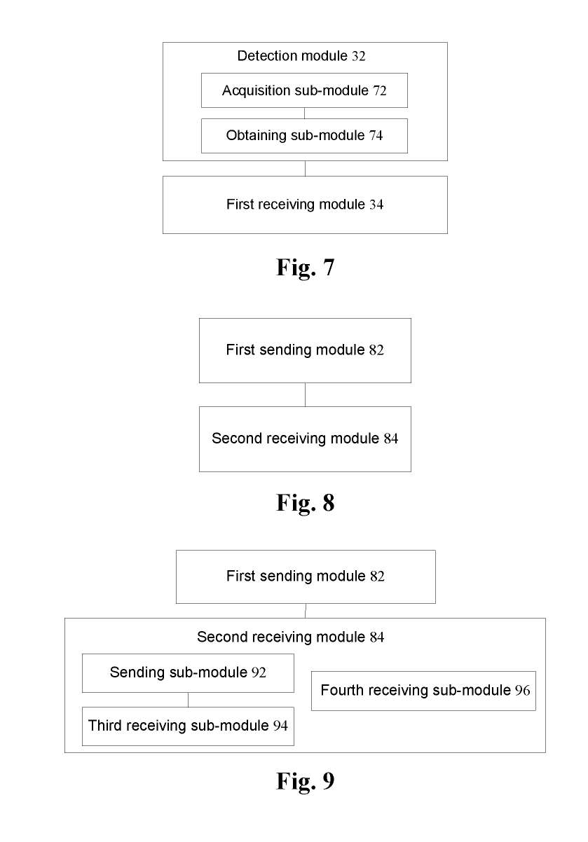

FIG. 7 is a block diagram 4 of a device for processing data transmission according to an exemplary embodiment of the present disclosure. As shown in FIG. 7, the detection module 32 includes an acquisition sub-module 72 and an obtaining sub-module 74.

the acquisition sub-module 72 is configured to acquire an ID of the target UE or the group ID, and the obtaining sub-module 74 is configured to detect and obtain the data scheduling information according to the ID of the target UE or the group ID, the data scheduling information being scrambled by the transmission node via the ID of the target UE or the group ID.

The embodiment of the present disclosure provides a device for processing data transmission, applied to a transmission node. FIG. 8 is a block diagram 2 of a device for processing data transmission according to an embodiment of the present disclosure. As shown in FIG. 8, the device includes a first sending module 82 and a second receiving module 84.

The first sending module 82 is configured to send data scheduling information to a target UE, and the second receiving module 84 is configured to receive data transmitted by an auxiliary UE, or data transmitted by the target UE and the auxiliary UE, the data transmitted by the auxiliary UE being data received by the auxiliary UE according to the data scheduling information and transmitted by the target UE to the transmission node.

FIG. 9 is a block diagram 5 of a device for processing data transmission according to an exemplary embodiment of the present disclosure. As shown in FIG. 9, the second receiving module 84 includes a sending sub-module 92, a third receiving sub-module 94 and/or a fourth receiving sub-module 96.

The sending sub-module 92 is configured to send retransmission data scheduling information or feedback information to the target UE.

The third receiving sub-module 94, configured to receive the data transmitted by the auxiliary UE to the transmission node according to the retransmission data scheduling information or the feedback information.

The fourth receiving sub-module 96 is configured to receive, after the auxiliary UE receives the data, the data retransmission over the same resource where the auxiliary UE and the target UE transmit the data.

In an exemplary implementation mode, the device may further include: a fifth receiving sub-module, configured to receive the data transmitted by the auxiliary UE in a predetermined mode, the predetermined mode including one of the following: independently transmitting the data by the target UE, independently transmitting the data by the auxiliary UE, and cooperatively retransmitting the data by the target UE and the auxiliary UE to decode the data respectively.

The data scheduling information may include auxiliary transmission mode information, and the auxiliary transmission mode information include whether the auxiliary UE receives data sent by the target UE, and/or whether the auxiliary UE transmits the received data to the transmission node.

In an exemplary implementation mode, the device may further include: a second sending module, configured to send configuration information to the auxiliary UE, the configuration information including at least one of the following: identification information of the target UE, transmission mode information of the target UE, and a type of a downlink control channel bearing the data scheduling information.

In an exemplary implementation mode, under the condition that the data scheduling information is transmitted by using an ePDCCH, the configuration information may further include configuration information associated with the ePDCCH, the configuration information associated with the ePDCCH including at least one of the following: a sub-frame position in which the ePDCCH is located, a start symbol position of OFDM, number of PRB sets, number and index of PRBs in PRB sets, a transmission mode, a scrambling initial value parameter, and a DMRS scrambling initial value.

In an exemplary implementation mode, the device may be further configured to send a group ID to the auxiliary UE and the target UE, the group ID being used for determining a search space for the data scheduling information.

In an exemplary implementation mode, the group ID and/or UE-specific ID may be used in at least one of the following modes: detecting a part of sub-frame sets by using the group ID, and detecting a part of sub-frame sets by using the UE-specific ID; defining two candidate resource sets, detecting one of the candidate resource sets by using the UE-specific ID, and detecting the other candidate resource set by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID.

The embodiment of the present disclosure also provides a device for processing data transmission, which includes: a third receiving module, configured to receive a group ID sent by a transmission node, the group ID being used for determining a search space for data scheduling information, and the data scheduling information being used for acquiring, by an auxiliary UE, data transmitted by the target UE to the transmission node.

In an exemplary implementation mode, the group ID and/or UE-specific ID may be used in at least one of the following modes: detecting a part of sub-frame sets by using the group ID, and detecting a part of sub-frame sets by using the UE-specific ID; defining candidate resource sets, detecting the resource set 1 by using the UE-specific ID, and detecting the resource set 2 by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID.

The data scheduling information may include: auxiliary transmission mode information, the auxiliary transmission mode information including: whether the auxiliary UE receives data sent by the target UE, and/or whether the auxiliary UE transmits the received data to the transmission node.

The embodiment of the present disclosure will be further illustrated hereinbelow in conjunction with an exemplary implementation mode.

A data transmission method provided in the embodiment of the present disclosure includes that: an auxiliary UE monitors data scheduling information sent by a transmission node to a target UE, and the auxiliary UE receives data sent by the target UE to the transmission node according to the data scheduling information, the data scheduling information including: scheduling information of the target UE sending data to the transmission node.

The auxiliary UE monitors retransmission data scheduling information or feedback information sent by the transmission node to the target UE, and the auxiliary UE transmits the received data of the target UE to the transmission node according to the retransmission data scheduling information or feedback information, the feedback information including: an ACK/Negative Acknowledgement (NACK) corresponding to data sent by the target UE to the transmission node, and a resource corresponding to the received data of the target UE transmitted by the auxiliary UE to the transmission node is identical to a resource corresponding to data retransmission by the target UE to the transmission node.

When the target UE retransmits the data over X sub-frames according to the scheduling information, the auxiliary UE transmits, after receiving the data, the data over Y sub-frames in the X sub-frames and over the same resource where the target UE retransmits the data, Y being a positive integer, and the mode of transmitting, by the auxiliary UE, the data is the same as the mode of retransmitting, by the target UE, the data, or the auxiliary UE transmits the data in a pre-defined mode or a mode indicated by the transmission node, or, the auxiliary UE directly forwards the data to the transmission node without decoding.

In an exemplary implementation mode, after receiving configuration information of the transmission node, the auxiliary UE detects DCI of the target UE according to the configuration information, the configuration information including at least one of the following: identification information of the target UE, transmission mode information of the target UE, and a type of a downlink control channel bearing the data scheduling information. When the data scheduling information is transmitted by using an ePDCCH, configuration information associated with the ePDCCH is further included, the configuration information associated with the ePDCCH including one or more of the following: a sub-frame position in which the ePDCCH is located, a start symbol position of OFDM, number of PRB sets, number and index of PRBs in PRB sets, a transmission mode, a scrambling initial value parameter, and a DMRS scrambling initial value parameter.

In an exemplary implementation mode, the data scheduling information further includes auxiliary data retransmission mode scheduling information, detection of the auxiliary data retransmission mode scheduling information may include at least one of the following: a search space for the scheduling information is detected only in a common search space; a time domain area where the scheduling information is detected is a specific sub-frame set; a DCI format corresponding to the scheduling information is a specific DCI format; and when an ePDCCH is adopted, an ePDCCH set correspondingly detecting the scheduling information is a specific value. The detection of the scheduling information further includes that: the auxiliary UE receives group ID information sent by the transmission node, a search space for data scheduling information corresponding to data, sent by the target UE, for auxiliary transmission being determined according to a group ID. The group ID and/or UE-specific ID are/is used in at least one of the following modes: detecting a part of sub-frame sets by using the group ID, and detecting a part of sub-frame sets by using the UE-specific ID; defining candidate resource sets, detecting the resource set 1 by using the UE-specific ID, and detecting the resource set 2 by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID. In addition, the auxiliary UE receives the auxiliary retransmission mode scheduling information sent by the transmission node.

The present exemplary embodiment provides a data transmission method, which includes that: a target UE receives group ID information sent by a transmission node, a search space for data scheduling information corresponding to data, sent by the target UE, for auxiliary transmission being determined according to a group ID. The group ID and/or UE-specific ID are/is used in at least one of the following modes: detecting a part of sub-frame sets by using the group ID, and detecting a part of sub-frame sets by using the UE-specific ID; defining candidate resource sets, detecting the resource set 1 by using the UE-specific ID, and detecting the resource set 2 by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID. The data scheduling information further includes auxiliary retransmission mode information.

The present exemplary embodiment also provides a data transmission method, which includes that: a transmission node sends auxiliary retransmission mode information to an auxiliary UE, the transmission node sends data scheduling information or feedback information to a target UE, and the transmission node receives data of the target UE according to the data scheduling information or the feedback information, and the step that the transmission node receives data of the target UE according to the data scheduling information or the feedback information specifically includes that: the transmission node individually retransmits the data according to the target UE, or the target UE and the auxiliary UE cooperatively repeat the data and decode the data respectively, or, the transmission node receives the data only in a data retransmission mode of the target UE.

The transmission node may send configuration information to the auxiliary UE, the configuration information including at least one of the following: ID information of the target UE, transmission mode information of the target UE, and a type of a downlink control channel bearing the data scheduling information. When the data scheduling information is transmitted by using an ePDCCH, configuration information associated with the ePDCCH is further included, the configuration information associated with the ePDCCH including one or more of the following: a sub-frame position in which the ePDCCH is located, a start symbol position of OFDM, number of PRB sets, number and index of PRBs in PRB sets, a transmission mode, a scrambling initial value parameter, and a DMRS scrambling initial value parameter.

The transmission node may also send group ID information to the auxiliary UE and the target UE, a search space for data scheduling information corresponding to data, sent by the target UE, for auxiliary transmission being determined according to a group ID. For the target UE, the group ID and/or UE-specific ID are/is used in at least one of the following modes: detecting a part of sub-frame sets by using the group ID, and detecting a part of sub-frame sets by using the UE-specific ID; defining candidate resource sets, detecting the resource set 1 by using the UE-specific ID, and detecting the resource set 2 by using the group ID; detecting a part of DCI formats by using the group ID, and detecting a part of DCI formats by using the UE-specific ID; and detection is performed in the common search space by using the group ID, and detection is performed in the common search space and the UE-specific search space by using the UE-specific ID, and the data scheduling information further include: auxiliary retransmission mode information.

The exemplary embodiment of the present disclosure will be further illustrated herein below in conjunction with a specific implementation mode.

A transmission node (base station) sends scheduling information to a target UE, the information instructing the target UE to send data to the transmission node over a sub-frame n An auxiliary UE may also monitor the scheduling information, and acquire a mode of sending, by the target UE, the data to the transmission node. The target UE sends the data to the transmission node over the sub-frame n in a scheduling information indicating mode, the auxiliary UE receives the data sent by the target UE to the transmission node in the scheduling information indicating mode, and the transmission node receives the data sent by the target UE to the transmission node in the scheduling information indicating mode.

Step 1-1: After receiving data sent by the target UE correctly, the transmission node sends ACK information to the target UE, and the auxiliary UE may monitor the information to learn of that the base station receives the data correctly, thus emptying the received data. The target UE empties the data after receiving the ACK information.

Step 1-2: After the transmission node does not receive the data sent by the target UE correctly, the transmission node sends NACK information or retransmission scheduling information to the target UE, and the target UE retransmits the data over a sub-frame n+k.

When monitoring the NACK information or the retransmission scheduling information, the auxiliary UE learns of that the base station does not receive the data correctly. If the auxiliary UE receives the data sent by the target UE correctly, the data are transmitted over a data retransmission resource, identical to the target UE, on the sub-frame n+k. The mode of transmitting, by the auxiliary UE, the data is the same as the mode of retransmitting, by the target UE, the data, or the auxiliary UE transmits the data in a pre-defined mode or a mode indicated by the transmission node. The transmission mode specifically includes: at least one of a transmission port, a pilot sequence selection, a scrambling identifier, a user ID, and a data mapping mode, and may include other pieces of information. If the auxiliary UE does not receive the data sent by the target UE correctly, retransmission data of the target UE are received over the sub-frame n+k, initial data and retransmission data of the data are merged, and the data are decoded.

Or, when the auxiliary UE monitors the NACK information, the auxiliary UE directly transmits the non-decoded data, received previously, over a data retransmission resource, identical to the target UE, on the sub-frame n+k. That is, the auxiliary UE directly forwards the data to the transmission node without decoding. At this time, the auxiliary UE is equivalent to a forwarder, which directly forwards the data of the UE without decoding.

It is important to note that the transmission node individually retransmits the data according to the target UE, and the target UE and the auxiliary UE cooperatively repeat the data and decode the data. If the transmission node cannot decode the data correctly, Step 1-2 is executed. If the transmission node can decode the data correctly, Step 1-1 is executed. Or, it is transparent to the transmission node that the auxiliary UE assists the target UE in data retransmission. The transmission node receives the data only in a data retransmission mode of the target UE. If the transmission node cannot decode the data correctly, Step 1-2 is executed. If the transmission node can decode the data correctly, Step 1-1 is executed.

Illustrations will be made herein below when the target UE and the auxiliary UE are under the same channel conditions.

When the target UE and the auxiliary UE are under the same channel conditions, for example, the two UEs are in a basement, or at a corner, the penetration loss from the two UEs to the transmission node (base station) is large. However, the penetration loss between the two UEs is small. At this time, the target UE needs to repeat data to the transmission node over X sub-frames, so the data receiving performance of the transmission node can be ensured.

The transmission node (base station) sends scheduling information to the target UE, the information instructing the target UE to send data to the transmission node over X sub-frames. The auxiliary UE may also monitor the scheduling information, and acquire a mode of sending, by the target UE, the data to the transmission node. The target UE sends the data to the transmission node over the X sub-frames in a scheduling information indicating mode, and the auxiliary UE receives the data sent by the target UE to the transmission node in the scheduling information indicating mode

Mode 1: Since channel conditions between the target UE and the auxiliary UE are better, the auxiliary UE may decode the data correctly after receiving the data over first Z in the X sub-frames, so the data are transmitted over the same resource, where the target UE retransmits the data, on the Y sub-frames in the X sub-frames after being correctly decoded, and the Y sub-frames may be pre-defined, or may be configured by the transmission node, or may be self-selected by the auxiliary UE. The mode of transmitting, by the auxiliary UE, the data is the same as the mode of retransmitting, by the target UE, the data.

Mode 2: The auxiliary UE receives the data sent by the target UE over a first sub-frame, and then, the auxiliary UE transmits the received non-decoded data over the same resource, where the target UE retransmits the data, on the Y sub-frames in the X sub-frames. At this time, the auxiliary UE is equivalent to a forwarder, which directly forwards the data of the UE without decoding.

The transmission node receives the data sent by the target UE to the transmission node in a scheduling information indicating mode. The transmission node individually retransmits the data according to the target UE, and the target UE and the auxiliary UE cooperatively repeat the data and decode the data. Or, it is transparent to the transmission node that the auxiliary UE assists the target UE in data retransmission, and the transmission node receives the data only in a data retransmission mode of the target UE.

Step 2-1: If receiving the data sent by the target UE correctly, the transmission node sends ACK information to the target UE, and the auxiliary UE may monitor the information to learn of that the base station receives the data correctly, thus emptying the received data. The target UE empties the data after receiving the ACK information.

Step 2-2: If the transmission node cannot decode the data correctly, the transmission node sends NACK information or retransmission scheduling information to the target UE, and the target UE retransmits the data over Xl sub-frames.

The auxiliary UE may also monitor the NACK information or retransmission scheduling information to learn of that the base station does not receive the data correctly. If the auxiliary UE receives the data sent by the target UE correctly, the data are transmitted over a data retransmission resource, identical to the target UE, on the X1 sub-frames. The mode of transmitting, by the auxiliary UE, the data is the same as the mode of retransmitting, by the target UE, the data. If the auxiliary UE does not receive the data sent by the target UE correctly, retransmission data of the target UE are received over the X1 sub-frames in the mode 1, initial data and retransmission data of the data are merged, and the data are decoded, or the received non-decoded data are transmitted over a data retransmission resource, identical to the target UE, on the X1 sub-frames in the mode 2.

The transmission node individually retransmits the data according to the target UE, and the target UE and the auxiliary UE cooperatively repeat the data and decode the data. Or, it is transparent to the transmission node that the auxiliary UE assists the target UE in data retransmission. The transmission node receives the data only in a data retransmission mode of the target UE. If the transmission node cannot decode the data correctly, Step 2-2 is executed. If the transmission node can decode the data correctly, Step 2-1 is executed.

In the exemplary embodiment of the present disclosure, the auxiliary UE may monitor and acquire the data scheduling information sent by the transmission node to the target UE and data transmitted by the transmission node to the target UE by using many modes. Illustrations with several typical examples will be made herein below.

The auxiliary UE receives configuration information of the transmission node, and detects DCI of the target UE according to the configuration information. When it is detected that the target UE has new data (initial data packet) to be sent to the transmission node over a sub-frame n and when the auxiliary UE does not have data to be sent over the sub-frame n, the new data (initial data packet) sent by the target UE are received at a frequency domain position indicated by DCI of the sub-frame n. After NACK information or retransmission DCI sent by the transmission node to the target UE is detected, the data sent by the target UE are received to the transmission node over a data retransmission resource of the target UE, and the configuration information includes at least one of the following: ID information of the target UE such as a C-RNTI and an SPS-RNTI, transmission mode information of the target UE, and a type of a downlink control channel bearing DCI such as a PDCCH and an ePDCCH. When the DCI is transmitted by using the ePDCCH, configuration information associated with the ePDCCH is further included, such as one or more of a sub-frame position in which the ePDCCH is located, a start symbol position of OFDM, number of PRB sets, number and index of PRBs in PRB sets, a transmission mode, a scrambling initial value parameter, and a DMRS scrambling initial value parameter. The search space for detecting the DCI may be only within a common search space, or within a common search space and a UE-specific search space, or only within a UE-specific search space for a user. The time domain area for detecting the DCI may be a specific sub-frame set. For example, the transmission node configures or pre-defines a sub-frame such as one or more of 0, 5, 4 and 9, or all sub-frame sets. The DCI format corresponding to the DCI may be a specific DCI format such as DCI format 0 or DCI format 0X. When an ePDCCH is adopted, a set corresponding to the ePDCCH is a specific value.

The transmission node configures the target UE and the auxiliary UE with group IDs, and a UE-specific search space for DCI corresponding to data sent by the target UE is determined according to the group IDs, so as to ensure that the target UE and the auxiliary UE may detect DCI in the same search space, and the auxiliary UE may obtain the DCI of the target UE. When sending the DCI corresponding to the target UE, the transmission node scrambles by using an ID of the target UE, so as to identify the information as target UE information. At this time, the auxiliary UE needs to obtain the ID of the target UE, in order to obtain the DCI sent by the transmission node to the target UE. In addition, scrambling may be conducted by using an in-group ID or the information may be identified as the UE information in the DCI, and the in-group ID may be pre-defined, or obtained according to a UE-specific ID, or configured by the transmission node. The group ID and/or UE-specific ID are/is used in at least one of the following modes: detecting a part of sub-frame sets by using the group ID, and detecting a part of sub-frame sets by using the UE-specific ID; defining candidate resource sets, detecting the resource set 1 by using the UE-specific ID, and detecting the resource set 2 by using the group ID; detecting a certain DCI format by using the group ID, and detecting a part of DCI formats by using the UE-specific ID; and detection is performed in the common search space by using the group ID, and detection is performed in the common search space and the UE-specific search space by using the UE-specific ID. A specific mode may be not limited to the above descriptions.

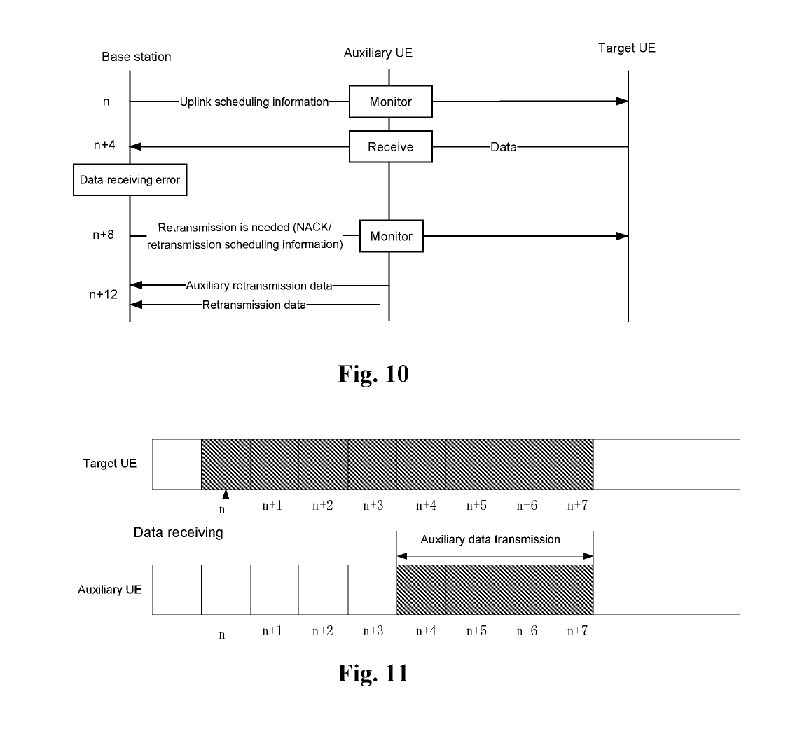

The base station transmits uplink scheduling information to the target UE over a sub-frame n, and both the auxiliary UE and the target UE monitor the scheduling information. The target UE transmits data to the base station over a corresponding resource according to the scheduling information sent by the base station over a sub-frame n+4, and the auxiliary UE receives the data sent by the target UE over the resource. The base station does not receive the data sent by the target UE correctly, and sends NACK or retransmission scheduling information to the target UE over a sub-frame n+8, both the auxiliary UE and the target UE monitor the information (NACK or retransmission scheduling information), the target UE retransmits the data over a sub-frame n+12 after receiving the information, and the auxiliary UE also transmits the retransmission data over the same retransmission resource. FIG. 10 is a schematic diagram 1 of UE collaboration data repeat according to an embodiment of the present disclosure. As shown in FIG. 10, a UE assistance-based data retransmission mode may be configured by a high-layer signalling, or dynamically indicated by a physical layer signalling. For example, the mode is indicated by a signalling in DCI sent by the transmission node to the target UE, so as to indicate whether the auxiliary UE needs to assist the target UE in data retransmission.

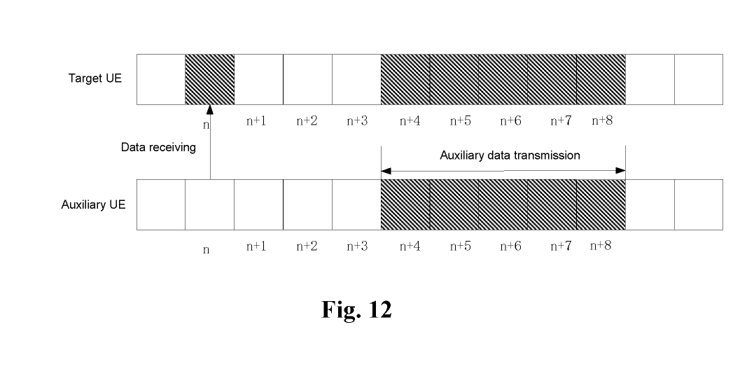

The target UE is in a coverage-enhanced mode. If the number of sub-frames needing to be retransmission is 8 (or may be other values such as 4, 6, 10, 12, 16, 20, 40, 80 and 100), the base station transmits uplink scheduling information to the target UE over a sub-frame n, and both the auxiliary UE and the target UE monitor the scheduling information. The target UE transmits data to the base station over a sub-frame n+4 in eight successive sub-frames according to the scheduling information sent by the base station, and the auxiliary UE starts receiving the data sent by the target UE over the sub-frame n, and starts assisting the target UE in retransmission the data over the same resource over the sub-frame n+4; and the base station starts adaptively receiving the data over the sub-frame n in the eight successive sub-frames. FIG. 11 is a schematic diagram 2 of UE collaboration data repeat according to an embodiment of the present disclosure. As shown in FIG. 11, a UE assistance-based data retransmission mode may be configured by a high-layer signalling, or dynamically indicated by a physical layer signalling. For example, the mode is indicated by a signalling in DCI sent by the transmission node to the target UE, so as to indicate whether the auxiliary UE needs to assist the target UE in data retransmission.

The target UE is in a coverage-enhanced mode. If the number of sub-frames needing to be retransmission is 6 (or may be other values such as 4, 6, 10, 12, 16, 20, 40, 80 and 100), the base station transmits uplink scheduling information to the target UE over a sub-frame n, and both the auxiliary UE and the target UE monitor the scheduling information. The target UE transmits data to the base station over sub-frames n+4, n+8, n+9, n+10, n+11 and n+12 according to the scheduling information sent by the base station, and the auxiliary UE starts receiving the data sent by the target UE over the sub-frame n, and starts assisting the target UE in retransmitting the data over the same resource over the sub-frame n+8; and the base station adaptively receives the data over the sub-frames n+4, n+8, n+9, n+10, n+11 and n+12. FIG. 12 is a schematic diagram 3 of UE collaboration data repeat according to an embodiment of the present disclosure. As shown in FIG. 12, since a certain time is needed between data receiving and data retransmission via the auxiliary UE, the target UE transmits data over non-successive sub-frames, so the auxiliary UE may start assisting in retransmission over a second data retransmission sub-frame of the target UE, the retransmission performance is improved as soon as possible, and the retransmission count of the target UE is decreased. The UE assistance-based data retransmission mode may be configured by a high-layer signalling, or dynamically indicated by a physical layer signalling. For example, the mode is indicated by a signalling in DCI sent by the transmission node to the target UE, so as to indicate whether the auxiliary UE needs to assist the target UE in data retransmission.

The auxiliary UE in the abovementioned embodiment may be a terminal, or may be an auxiliary transmission node such as a microcell, a smallcell, a Femtocell, or a relay node. A specific process is identical to an auxiliary data transmission process of an auxiliary terminal, the auxiliary UE being only replaced with the auxiliary transmission node.

By using the abovementioned exemplary embodiment, an auxiliary terminal assists a main terminal in data retransmission, thus improving the data transmission performance, improving the resource utilization efficiency, solving the problem of reduced system resource efficiency resulting from an existing data transmission solution under a specific scenario, reducing the data transmission delay, and improving the data transmission reliability.

Industrial applicability: from the above descriptions, it may be seen that the auxiliary terminal assists the main terminal in data retransmission, so the data transmission performance and the resource utilization efficiency may be improved.

Obviously, those skilled in the art shall understand that all of the abovementioned modules or steps in the present disclosure may be implemented by using a general calculation device, may be centralized on a single calculation device or may be distributed on a network composed of a plurality of calculation devices. Exemplary, they may be implemented by using executable program codes of the calculation devices. Thus, they may be stored in a storage device and executed by the calculation devices, the shown or described steps may be executed in a sequence different from this sequence under certain conditions, or they are manufactured into each integrated circuit module respectively, or multiple modules or steps therein are manufactured into a single integrated circuit module. Thus, the present disclosure is not limited to a combination of any specific hardware and software.

The above is only the preferred embodiments of the present disclosure, and not intended to limit the present disclosure. There may be various modifications and variations in the present disclosure for those skilled in the art. Any modifications, equivalent replacements, improvements and the like shall fall within the scope of protection of the present disclosure.

1. A method for processing data transmission, comprising:
detecting, by an auxiliary User Equipment (UE), data scheduling information sent by a transmission node to a target UE, wherein the data scheduling information comprises scheduling information of the target UE sending data to the transmission node; and
receiving, by the auxiliary UE, the data sent by the target UE to the transmission node according to the data scheduling information.

2. The method according to claim 1, further comprising:
transmitting, by the auxiliary UE, the received data to the transmission node; or,
when the auxiliary UE confirms that it is unnecessary to transmit the received data to the transmission node, emptying the received data.

3. The method according to claim 2, wherein transmitting, by the auxiliary UE, the received data to the transmission node comprises:
detecting, by the auxiliary UE, retransmission data scheduling information or feedback information sent by the transmission node to the target UE; transmitting, by the auxiliary UE, the received data to the transmission node according to the retransmission data scheduling information or feedback information;
and/or,
transmitting, by the auxiliary UE, the received data over a resource where the target UE retransmits the data.

4. The method according to claim 3, wherein transmitting, by the auxiliary UE, the received data over a resource where the target UE retransmits the data after receiving the data comprises:
when the target UE transmits data over X sub-frames according to the data scheduling information, transmitting, by the auxiliary UE, the received data over Y sub-frames in the X sub-frames and over the resource where the target UE retransmits the data.

5. The method according to claim 2, wherein transmitting, by the auxiliary UE, the received data to the transmission node comprises one of the following steps:
transmitting, by the auxiliary UE, the received data to the transmission node in the same mode as the target UE transmits or retransmits the data;
transmitting, by the auxiliary UE, the received data to the transmission node in a pre-defined mode;
transmitting, by the auxiliary UE, the received data to the transmission node in a mode indicated by the transmission node; and
directly forwarding, by the auxiliary UE, the data to the transmission node without decoding.

6. The method according to claim 1, wherein the data scheduling information comprises auxiliary transmission mode information, and the auxiliary transmission mode information comprising: whether the auxiliary UE receives data sent by the target UE, and/or whether the auxiliary UE transmits the received data to the transmission node.

7. The method according to claim 2, wherein confirming, by the auxiliary UE, that it is unnecessary to transmit the received data to the transmission node comprises:
after detecting an information Acknowledgement (ACK), sent by the transmission node to the target UE, for confirming successful data receiving, confirming, by the auxiliary UE, that it is unnecessary to transmit the received data to the transmission node.

8. The method according to claim 1, wherein detecting, by the auxiliary UE, the data scheduling information sent by the transmission node to the target UE comprises:
receiving, by the auxiliary UE, configuration information sent by the transmission node, the configuration information comprising at least one of the following: identification information of the target UE, transmission mode information of the target UE, information about a downlink control channel bearing the data scheduling information, and trigger information for triggering the auxiliary UE to assist the target UE in data transmission; and
detecting, by the auxiliary UE, the data scheduling information according to the configuration information.

9. The method according to claim 8, wherein under the condition that the data scheduling information is transmitted by using an enhanced Physical Downlink Control Channel (ePDCCH), the configuration information further comprises configuration information associated with the ePDCCH, and the configuration information associated with the ePDCCH comprising at least one of the following: a sub-frame position in which the ePDCCH is located, a start symbol position of Orthogonal Frequency Division Multiplexing (OFDM), number of Physical Resource Block (PRB) sets, number and index of PRBs in PRB sets, a transmission mode, a scrambling initial value parameter, and a Demodulation Reference Signal (DMRS) scrambling initial value.

10. The method according to claim 1, wherein detecting, by the auxiliary UE, the data scheduling information comprises at least one of the following steps:
detecting, by the auxiliary UE, the data scheduling information only in a common search space, or only in a UE-specific search space, or in a common search space and a UE-specific search space;
detecting, by the auxiliary UE, the data scheduling information in a specific sub-frame set;
detecting, by the auxiliary UE, the data scheduling information according to a specific Downlink Control Information (DCI) format; and
under the condition that the data scheduling information is transmitted by using the ePDCCH, detecting, by the auxiliary UE, the data scheduling information by using a specific ePDCCH set.

11. The method according to claim 1, wherein detecting, by the auxiliary UE, the data scheduling information comprises:
receiving, by the auxiliary UE, a group Identity (ID) sent by the transmission node, a search space of the data scheduling information being determined according to the group ID; and
detecting, by the auxiliary UE, the data scheduling information in the search space determined according to the group ID.

12. The method according to claim 11, wherein the group ID and/or UE-specific ID are/is used in at least one of the following modes:
detecting a part of sub-frame sets by using the group ID, and detecting a part of sub-frame sets by using the UE-specific ID;
defining two candidate resource sets, detecting one of the candidate resource sets by using the UE-specific ID, and detecting the other candidate resource set by using the group ID;
detecting a part of DCI formats by using the group ID, and detecting a part of DCI formats by using the UE-specific ID; and
detection is performed in the common search space by using the group ID, and detection is performed in the common search space and the UE-specific search space by using the UE-specific ID.

13. The method according to claim 11, wherein detecting, by the auxiliary UE, the data scheduling information comprises:
acquiring, by the auxiliary UE, an ID of the target UE or the group ID; and
detecting and obtaining, by the auxiliary UE, the data scheduling information according to the ID of the target UE or the group ID, and the data scheduling information being scrambled by the transmission node via the ID of the target UE or the group ID.

14. A method for processing data transmission, comprising:
sending, by a transmission node, data scheduling information to a target User Equipment (UE); and
receiving, by the transmission node, data transmitted by an auxiliary UE, or data transmitted by the target UE and the auxiliary UE, wherein the data transmitted by the auxiliary UE being data received by the auxiliary UE according to the data scheduling information and transmitted by the target UE to the transmission node.

15. The method according to claim 14, wherein receiving, by the transmission node, data transmitted by the auxiliary UE comprises:
sending, by the transmission node, retransmission data scheduling information or feedback information to the target UE; and receiving, by the transmission node, data retransmission by the target UE and/or the auxiliary UE, the data retransmission by the auxiliary UE being the received data transmitted to the transmission node according to the retransmission data scheduling information or the feedback information;
and/or,
after the auxiliary UE receives the data, receiving, by the transmission node, the data retransmission by the target UE and/or the data transmitted by the auxiliary UE over a resource where the target UE retransmits the data.

16. The method according to claim 14, wherein the transmission node receives the data in a predetermined mode, the predetermined mode comprising one of the following:
independently transmitting the data by the target UE, independently transmitting the data by the auxiliary UE, and cooperatively retransmitting the data by the target UE and the auxiliary UE to decode the data respectively.

17. The method according to claim 14, wherein the data scheduling information comprises auxiliary transmission mode information, and the auxiliary transmission mode information comprising: whether the auxiliary UE receives data sent by the target UE, and/or whether the auxiliary UE transmits the received data to the transmission node.

18. The method according to claim 14, further comprising:
sending, by the transmission node, configuration information to the auxiliary UE, the configuration information comprising at least one of the following: identification information of the target UE, transmission mode information of the target UE, information about a downlink control channel bearing the data scheduling information, and trigger information for triggering the auxiliary UE to assist the target UE in data transmission.

19. The method according to claim 18, wherein under the condition that the data scheduling information is transmitted by using an enhanced Physical Downlink Control Channel (ePDCCH), the configuration information further comprises configuration information associated with the ePDCCH, and the configuration information associated with the ePDCCH comprising at least one of the following: a sub-frame position in which the ePDCCH is located, a start symbol position of Orthogonal Frequency Division Multiplexing (OFDM), number of Physical Resource Block (PRB) sets, number and index of PRBs in PRB sets, a transmission mode, a scrambling initial value parameter, and a Demodulation Reference Signal (DMRS) scrambling initial value.

20. The method according to claim 14, further comprising:
sending, by the transmission node, a group Identity (ID) to the auxiliary UE and the target UE, the group ID being used for determining a search space for the data scheduling information.

21. The method according to claim 20, wherein the group ID and/or UE-specific ID are/is used in at least one of the following modes:
detecting a part of sub-frame sets by using the group ID, and detecting a part of sub-frame sets by using the UE-specific ID;
defining two candidate resource sets, detecting one of the candidate resource sets by using the UE-specific ID, and detecting the other candidate resource set by using the group ID;
detecting a part of Downlink Control Information (DCI) formats by using the group ID, and detecting a part of DCI formats by using the UE-specific ID; and
detection is performed in the common search space by using the group ID, and detection is performed in the common search space and the UE-specific search space by using the UE-specific ID.

22-48. (canceled)
